(19) United States
(12) Patent Application Publication
(10) Pub. No.: US 2026/0051812 A1
(43) Pub. Date: Feb. 19, 2026

(54) POWER CONVERSION CIRCUIT

(71) Applicant: Lite-On Technology Corporation, Taipei (TW)

(72) Inventor: Hsu-Chin Wu, Taipei (TW)

(73) Assignee: Lite-On Technology Corporation, Taipei (TW)

(21) Appl. No.: 19/299,342

(22) Filed: Aug. 14, 2025

Related U.S. Application Data
(60) Provisional application No. 63/682,797, filed on Aug. 14, 2024.

(51) Int. Cl. H02M 3/00; H02M 3/335

(52) U.S. Cl. CPC H02M 3/01; H02M 3/3353

(57) ABSTRACT

A power conversion circuit is provided. The power conversion circuit includes a series transformer circuit and a primary side circuit. The series transformer circuit includes a first phase transformer circuit, a second phase transformer circuit and a third phase transformer circuit. The primary side circuit includes a first node, a second node and a third node. A primary winding of the first phase transformer circuit and a primary winding of the second phase transformer circuit are connected in series between the first node and the second node. The primary winding of the first phase transformer circuit and a primary winding of the third phase transformer circuit are connected in series between the first node and the third node. The primary winding of the second phase transformer circuit and the primary winding of the third phase transformer circuit are connected in series between the second node and the third node.

### CROSS-REFERENCE TO RELATED APPLICATION

This application claims the priority benefit of U.S. provisional application Ser. No. 63/682,797, filed on Aug. 14, 2024. The entirety of the above-mentioned patent application is hereby incorporated by reference herein and made a part of this specification.

### BACKGROUND

### Technical Field

The disclosure relates to a power conversion circuit.

### Related Art

Generally, a power conversion circuit may be implemented by an LCC resonant converter. A power limit of the general LCC resonant converter is approximately 8 kW. In an application of higher power, a transformer of the LCC resonant converter may be overheating or entering an abnormal condition. A used number of LCC resonant converters must increase. In other words, the used number of LCC resonant converters of the power conversion circuit may increase with an increase in required power. Therefore, an occupied space of multiple LCC resonant converters is inevitably increased.

For example, the power conversion circuit may be configured to supply power to multiple servers in a server cabinet. The required power in the server cabinet may be higher than 30 kW. Therefore, the power conversion circuit needs four LCC resonant converters. The space occupied by the power conversion circuit in the server cabinet is increased. As a result, in the application of higher power, how to reduce a volume of the LCC resonant converters so as to reduce the occupied space is one of the research issues for those skilled in the art.

### SUMMARY

The disclosure provides a power conversion circuit for high power.

In an embodiment of the disclosure, the power conversion circuit includes a series transformer circuit, a primary side circuit, and a secondary side circuit. The series transformer circuit includes a first phase transformer circuit, a second phase transformer circuit, and a third phase transformer circuit. The primary side circuit includes a first phase node, a second phase node, a third phase node, a first phase resonant tank, a second phase resonant tank, and a third phase resonant tank. The first phase resonant tank, the second phase resonant tank, at least one primary winding of the first phase transformer circuit, and at least one primary winding of the second phase transformer circuit are connected in series between the first phase node and the second phase node. The first phase resonant tank, the third phase resonant tank, at least one primary winding of the first phase transformer circuit, and at least one primary winding of the third phase transformer circuit are connected in series between the first phase node and the third phase node. The second phase resonant tank, the third phase resonant tank, at least one primary winding of the second phase transformer circuit, and at least one primary winding of the third phase transformer circuit are connected in series between the second phase node and the third phase node. The secondary side circuit is connected to at least one secondary winding of the first phase transformer circuit, at least one secondary winding of the second phase transformer circuit, and at least one secondary winding of the third phase transformer circuit.

In an embodiment of the disclosure, the primary side circuit further includes a first phase upper arm power switch and a first phase lower arm power switch. A first terminal of the first phase upper arm power switch is connected to a positive power terminal of an input voltage source. A second terminal of the first phase upper arm power switch is connected to the first phase node. A first terminal of the first phase lower arm power switch is connected to the first phase node. A second terminal of the first phase lower arm power switch is connected to a negative power terminal of the input voltage source.

In an embodiment of the disclosure, the first phase transformer circuit includes a first transformer. The first transformer includes a first primary winding. The second phase transformer circuit includes a second transformer. The second transformer includes a second primary winding. The first primary winding and the second primary winding are connected in series between the first phase resonant tank and the second phase resonant tank.

In an embodiment of the disclosure, the third phase transformer circuit includes a third transformer. The third transformer includes a third primary winding. The first primary winding and the third primary winding are connected in series between the first phase resonant tank and the third phase resonant tank.

In an embodiment of the disclosure, the second primary winding and the third primary winding are connected in series between the second phase resonant tank and the third phase resonant tank.

In an embodiment of the disclosure, the secondary side circuit includes a synchronous rectifier circuit and a power output circuit. The synchronous rectifier circuit is connected to at least one secondary winding of the first phase transformer circuit, at least one secondary winding of the second phase transformer circuit, and at least one secondary winding of the third phase transformer circuit. The power output circuit is connected to the synchronous rectifier circuit.

In an embodiment of the disclosure, the first phase transformer circuit includes a first transformer and a second transformer. The first transformer includes a first primary winding and a first secondary winding. The second transformer includes a second primary winding and a second secondary winding. The second phase transformer circuit includes a third transformer and a fourth transformer. The third transformer includes a third primary winding and a third secondary winding. The fourth transformer includes a fourth primary winding and a fourth secondary winding. The first primary winding, the second primary winding, the third primary winding, and the fourth primary winding are connected in series between the first phase resonant tank and the second phase resonant tank.

In an embodiment of the disclosure, the third phase transformer circuit includes a fifth transformer and a sixth transformer. The fifth transformer includes a fifth primary winding and a fifth secondary winding. The sixth transformer includes a sixth primary winding and a sixth secondary winding. The first primary winding, the second primary winding, the fifth primary winding, and the sixth primary winding are connected in series between the first phase resonant tank and the third phase resonant tank.

In an embodiment of the disclosure, the third primary winding, the fourth primary winding, the fifth primary winding, and the sixth primary winding are connected in series between the second phase resonant tank and the third phase resonant tank.

In an embodiment of the disclosure, the secondary side circuit includes a first synchronous rectifier circuit, a second synchronous rectifier circuit, and a power output circuit. The first synchronous rectifier circuit is connected to the first secondary winding, the third secondary winding, and the fifth secondary winding. The second synchronous rectifier circuit is connected to the second secondary winding, the fourth secondary winding, and the sixth secondary winding. The power output circuit is connected to the first synchronous rectifier circuit and the second synchronous rectifier circuit.

In an embodiment of the disclosure, the first synchronous rectifier circuit includes a first rectifier node, a second rectifier node, and a third rectifier node. The first secondary winding and the third secondary winding are connected in series between the first rectifier node and the second rectifier node. The first secondary winding and the fifth secondary winding are connected in series between the first rectifier node and the third rectifier node. The third secondary winding and the fifth secondary winding are connected in series between the second rectifier node and the third rectifier node.

In an embodiment of the disclosure, the second synchronous rectifier circuit includes a fourth rectifier node, a fifth rectifier node, and a sixth rectifier node. The second secondary winding and the fourth secondary winding are connected in series between the fourth rectifier node and the fifth rectifier node. The second secondary winding and the sixth secondary winding are connected in series between the fourth rectifier node and the sixth rectifier node. The fourth secondary winding and the sixth secondary winding are connected in series between the fifth rectifier node and the sixth rectifier node.

In an embodiment of the disclosure, the first synchronous rectifier circuit further includes a first synchronous rectifier switch and a second synchronous rectifier switch. A first terminal of the first synchronous rectifier switch is connected to a positive power output terminal of the power conversion circuit. A second terminal of the first synchronous rectifier switch is connected to the first rectifier node. A first terminal of the second synchronous rectifier switch is connected to the first rectifier node. A second terminal of the second synchronous rectifier switch is connected to a negative power output terminal of the power conversion circuit.

In an embodiment of the disclosure, a timing of a ripple of a current output by the first synchronous rectifier circuit is different from a timing of a ripple of a current output by the second synchronous rectifier circuit.

In an embodiment of the disclosure, the series transformer circuit further includes a fourth phase transformer circuit. The primary side circuit further includes a fourth phase node and a fourth phase resonant tank. The first phase resonant tank, the fourth phase resonant tank, at least one primary winding of the first phase transformer circuit, and at least one primary winding of the fourth phase transformer circuit are connected in series between the first phase node and the fourth phase node.

In an embodiment of the disclosure, the primary side circuit further includes a first circuit and a second circuit. The first circuit includes the first phase node, the second phase node, the third phase node, the first phase resonant tank, the second phase resonant tank, and the third phase resonant tank. The second circuit includes a fourth phase node, a fifth phase node, a sixth phase node, a fourth phase resonant tank, a fifth phase resonant tank, and a sixth phase resonant tank. The first circuit and the second circuit are stacked between the positive power terminal of the input voltage source and the negative power terminal of the input voltage source.

In an embodiment of the disclosure, the series transformer circuit further includes a fourth phase transformer circuit, a fifth phase transformer circuit, and a sixth phase transformer circuit. The fourth phase resonant tank, the fifth phase resonant tank, at least one primary winding of the fourth phase transformer circuit, and at least one primary winding of the fifth phase transformer circuit are connected in series between the fourth phase node and the fifth phase node. The fourth phase resonant tank, the sixth phase resonant tank, at least one primary winding of the fourth phase transformer circuit, and at least one primary winding of the sixth phase transformer circuit are connected in series between the fourth phase node and the sixth phase node. The fifth phase resonant tank, the sixth phase resonant tank, at least one primary winding of the fifth phase transformer circuit, and at least one primary winding of the sixth phase transformer circuit are connected in series between the fifth phase node and the sixth phase node.

In an embodiment of the disclosure, the first circuit and the second circuit are connected to an intermediate voltage node. A voltage value at the intermediate voltage node is equal to one-half of a voltage value of the input voltage source.

In an embodiment of the disclosure, the power conversion circuit further includes a voltage balancing circuit. The voltage balancing circuit is connected to the intermediate voltage node. The voltage balancing circuit controls the voltage value at the intermediate voltage node to be one-half of the voltage value of the input voltage source.

In an embodiment of the disclosure, the voltage balancing circuit includes a first capacitor and a second capacitor. The first capacitor is connected between the positive power terminal of the input voltage source and the intermediate voltage node. The second capacitor is connected between the intermediate voltage node and the negative power terminal of the input voltage source.

Based on the above, the first phase resonant tank, the second phase resonant tank, at least one primary winding of the first phase transformer circuit, and at least one primary winding of the second phase transformer circuit are connected in series between the first phase node and the second phase node. The first phase resonant tank, the third phase resonant tank, at least one primary winding of the first phase transformer circuit, and at least one primary winding of the third phase transformer circuit are connected in series between the first phase node and the third phase node. The second phase resonant tank, the third phase resonant tank, at least one primary winding of the second phase transformer circuit, and at least one primary winding of the third phase transformer circuit are connected in series between the second phase node and the third phase node. The first phase transformer circuit, the second phase transformer circuit, and the third phase transformer circuit share the same primary side circuit. In this way, the space occupied by the power conversion circuit may be reduced.

### BRIEF DESCRIPTION OF THE DRAWINGS

FIG. 1 is a schematic diagram of a power conversion circuit according to an embodiment of the disclosure.

FIG. 2 is a schematic diagram of a power conversion circuit according to an embodiment of the disclosure.

FIG. 3 is a timing diagram of switching signals according to an embodiment of the disclosure.

FIG. 4 is a schematic diagram of a power conversion circuit according to an embodiment of the disclosure.

FIG. 5 is a schematic diagram of a power conversion circuit according to an embodiment of the disclosure.

FIG. 6 is a schematic diagram of a power conversion circuit according to an embodiment of the disclosure.

FIG. 7 is a schematic diagram of a power conversion circuit according to an embodiment of the disclosure.

FIG. 8 is a timing diagram of switching signals according to an embodiment of the disclosure.

FIG. 9 is a schematic diagram of a power conversion circuit according to an embodiment of the disclosure.

### DESCRIPTION OF THE EMBODIMENTS

Some embodiments of the disclosure are described in detail with reference to the accompanying drawings. In the following description, when appearing in different drawings, the same reference numerals are regarded as the same or similar elements. These embodiments are only a part of the disclosure and do not disclose all possible implementations of the disclosure. More specifically, these embodiments are merely examples within the scope of the patent application of the disclosure.

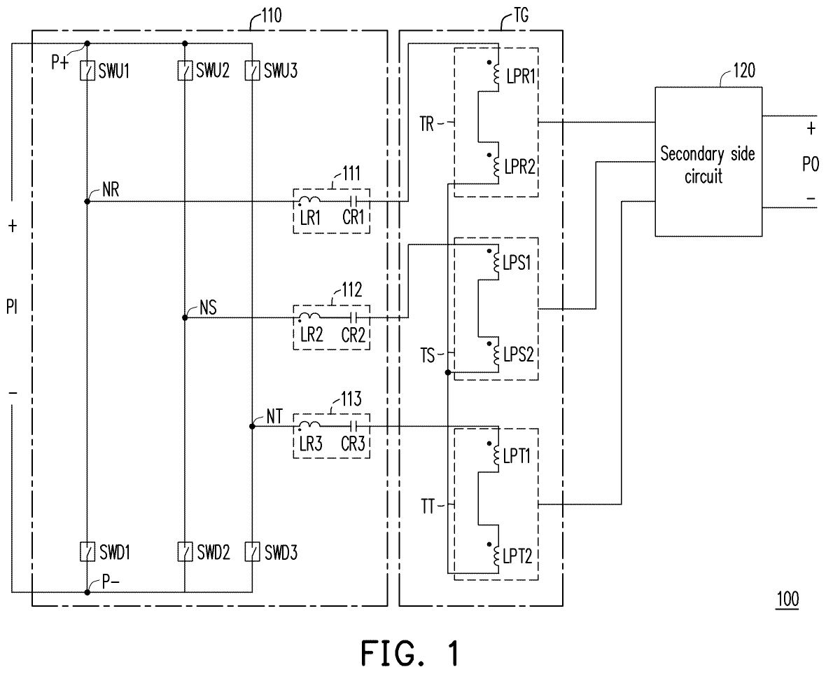

FIG. 1 is a schematic diagram of a power conversion circuit according to an embodiment of the disclosure. In this embodiment, a power conversion circuit 100 includes a series transformer circuit TG, a primary side circuit 110, and a secondary side circuit 120. The series transformer circuit TG includes a first phase transformer circuit TR, a second phase transformer circuit TS, and a third phase transformer circuit TT. In this embodiment, the first phase transformer circuit TR includes primary windings LPR1 and LPR2. The second phase transformer circuit TS includes primary windings LPS1 and LPS2. The third phase transformer circuit TT includes primary windings LPT1 and LPT2. The primary windings LPR1 and LPR2 may be respectively in different transformers (not shown in FIG. 1) of the first phase transformer circuit TR. The primary windings LPS1 and LPS2 may be respectively in different transformers (not shown in FIG. 1) of the second phase transformer circuit TS. The primary windings LPT1 and LPT2 may be respectively in different transformers (not shown in FIG. 1) of the third phase transformer circuit TT.

In this embodiment, the primary side circuit 110 is connected to the first phase transformer circuit TR, the second phase transformer circuit TS, and the third phase transformer circuit TT. The primary side circuit 110 includes a first phase node NR, a second phase node NS, a third phase node NT, a first phase resonant tank 111, a second phase resonant tank 112, and a third phase resonant tank 113.

The first phase resonant tank 111, the second phase resonant tank 112, the primary windings LPR1 and LPR2 of the first phase transformer circuit TR, and the primary windings LPS1 and LPS2 of the second phase transformer circuit TS are connected in series between the first phase node NR and the second phase node NS. The first phase resonant tank 111, the third phase resonant tank 113, the primary windings LPR1 and LPR2 of the first phase transformer circuit TR, and the primary windings LPT1 and LPT2 of the third phase transformer circuit TT are connected in series between the first phase node NR and the third phase node NT. In addition, the second phase resonant tank 112, the third phase resonant tank 113, the primary windings LPS1 and LPS2 of the second phase transformer circuit TS, and the primary windings LPT1 and LPT2 of the third phase transformer circuit TT are connected in series between the second phase node NS and the third phase node NT.

The secondary side circuit 120 is connected to a secondary winding (not shown in FIG. 1) of the first phase transformer circuit TR, a secondary winding (not shown in FIG. 1) of the second phase transformer circuit TS, and a secondary winding (not shown in FIG. 1) of the third phase transformer circuit TT. The secondary side circuit 120 outputs output power PO.

In this embodiment, the first phase transformer circuit TR, the second phase transformer circuit TS, and the third phase transformer circuit TT are used for voltage conversion. For example, the first phase transformer circuit TR, the second phase transformer circuit TS, and the third phase transformer circuit TT each include at least one transformer. A power upper limit of the transformer is 8 kW. The primary windings LPR1, LPR2, LPS1, LPS2, LPT1, LPT2 and an iron core may be elements of the corresponding transformer.

It is worth mentioning here that the first phase transformer circuit TR, the second phase transformer circuit TS, and the third phase transformer circuit TT share the same primary side circuit 110. In this way, the space occupied by the power conversion circuit 100 may be reduced.

In this embodiment, the primary side circuit 110 further includes a first phase upper arm power switch SWU1, a second phase upper arm power switch SWU2, a third phase upper arm power switch SWU3, a first phase lower arm power switch SWD1, a second phase lower arm power switch SWD2, and a third phase lower arm power switch SWD3. The first phase upper arm power switch SWU1 and the first phase lower arm power switch SWD1 are a first phase half-bridge arm of the primary side circuit 110. The second phase upper arm power switch SWU2 and the second phase lower arm power switch SWD2 are a second phase half-bridge arm of the primary side circuit 110. The third phase upper arm power switch SWU3 and the third phase lower arm power switch SWD3 are a third phase half-bridge arm of the primary side circuit 110. Therefore, the power conversion circuit 100 is a 3-phase LLC converter.

A first terminal of the first phase upper arm power switch SWU1 is connected to a positive power terminal P+ of an input voltage source PI. A second terminal of the first phase upper arm power switch SWU1 is connected to the first phase node NR. A first terminal of the first phase lower arm power switch SWD1 is connected to the first phase node NR. A second terminal of the first phase lower arm power switch SWD1 is connected to a negative power terminal P− of the input voltage source PI.

A first terminal of the second phase upper arm power switch SWU2 is connected to the positive power terminal P+ of the input voltage source PI. A second terminal of the second phase upper arm power switch SWU2 is connected to the second phase node NS. A first terminal of the second phase lower arm power switch SWD2 is connected to the second phase node NS. A second terminal of the second phase lower arm power switch SWD2 is connected to the negative power terminal P− of the input voltage source PI. A first terminal of the third phase upper arm power switch SWU3 is connected to the positive power terminal P+ of the input voltage source PI. A second terminal of the third phase upper arm power switch SWU3 is connected to the third phase node NT. A first terminal of the third phase lower arm power switch SWD3 is connected to the third phase node NT. A second terminal of the third phase lower arm power switch SWD3 is connected to the negative power terminal P− of the input voltage source PI.

In this embodiment, the first phase resonant tank 111 includes a resonant inductor LR1 and a resonant capacitor CR1. The resonant inductor LR1 and the resonant capacitor CR1 are connected in series between the first phase node NR and the first phase transformer circuit TR. The second phase resonant tank 112 includes a resonant inductor LR2 and a resonant capacitor CR2. The resonant inductor LR2 and the resonant capacitor CR2 are connected in series between the second phase node NS and the second phase transformer circuit TS. The third phase resonant tank 113 includes a resonant inductor LR3 and a resonant capacitor CR3. The resonant inductor LR3 and the resonant capacitor CR3 are connected in series between the third phase node NT and the third phase transformer circuit TT.

It should be noted that the primary windings LPR1 and LPR2 of the first phase transformer circuit TR and the primary windings LPS1 and LPS2 of the second phase transformer circuit TS are connected in series between the first phase resonant tank 111 and the second phase resonant tank 112. The primary windings LPR1 and LPR2 of the first phase transformer circuit TR and the primary windings LPT1 and LPT2 of the third phase transformer circuit TT are connected in series between the first phase resonant tank 111 and the third phase resonant tank 113. The primary windings LPS1 and LPS2 of the second phase transformer circuit TS and the primary windings LPT1 and LPT2 of the third phase transformer circuit TT are connected in series between the second phase resonant tank 112 and the third phase resonant tank 113. Therefore, the primary windings LPR1, LPR2, LPS1, LPS2, LPT1, and LPT2 are connected in a “Y” type connection manner.

In some embodiments, the first phase transformer circuit TR includes a primary winding LPR1. The second phase transformer circuit TS includes a primary winding LPS1. The third phase transformer circuit TT includes a primary winding LPT1. The disclosure is not limited by a number of primary windings of the first phase transformer circuit TR, a number of primary windings of the second phase transformer circuit TS, and a number of primary windings of the third phase transformer circuit TT.

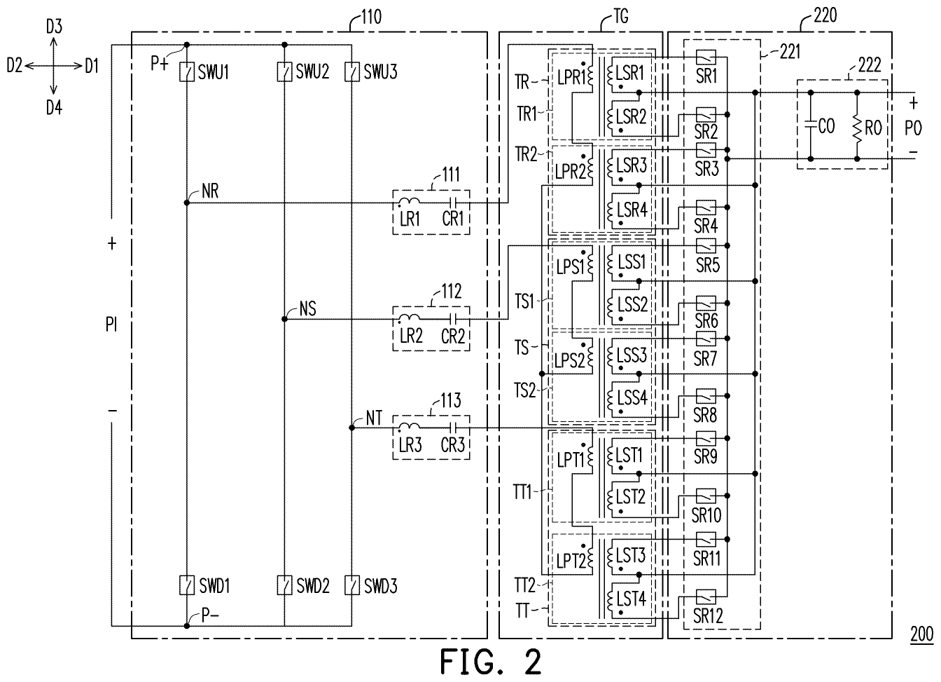

FIG. 2 is a schematic diagram of a power conversion circuit according to an embodiment of the disclosure. In this embodiment, a power conversion circuit 200 includes a series transformer circuit TG, a primary side circuit 110, and a secondary side circuit 220. The series transformer circuit TG includes a first phase transformer circuit TR, a second phase transformer circuit TS, and a third phase transformer circuit TT. The first phase transformer circuit TR includes transformers TR1 and TR2. The second phase transformer circuit TS includes transformers TS1 and TS2. The third phase transformer circuit TT includes transformers TT1 and TT2.

The transformer TR1 includes a primary winding LPR1 and secondary windings LSR1 and LSR2. The transformer TR2 includes a primary winding LPR2 and secondary windings LSR3 and LSR4. The transformer TS1 includes a primary winding LPS1 and secondary windings LSS1 and LSS2. The transformer TS2 includes a primary winding LPS2 and secondary windings LSS3 and LSS4. The transformer TT1 includes a primary winding LPT1 and secondary windings LST1 and LST2. The transformer TT2 includes a primary winding LPT2 and secondary windings LST3 and LST4.

In this embodiment, the connection manners of the primary side circuit 110, the first phase transformer circuit TR, the second phase transformer circuit TS, and the third phase transformer circuit TT has been clearly described in the embodiment of FIG. 1. The primary windings LPR1 and LPR2 of the first phase transformer circuit TR and the primary windings LPS1 and LPS2 of the second phase transformer circuit TS are connected in series between the first phase resonant tank 111 and the second phase resonant tank 112. The primary windings LPR1 and LPR2 of the first phase transformer circuit TR and the primary windings LPT1 and LPT2 of the third phase transformer circuit TT are connected in series between the first phase resonant tank 111 and the third phase resonant tank 113. The primary windings LPS1 and LPS2 of the second phase transformer circuit TS and the primary windings LPT1 and LPT2 of the third phase transformer circuit TT are connected in series between the second phase resonant tank 112 and the third phase resonant tank 113. The primary windings LPR1, LPR2, LPS1, LPS2, LPT1, and LPT2 are connected in the “Y”type connection manner.

The designs of the transformers TR1, TR2, TS1, TS2, TT1, and TT2 are substantially similar. In this embodiment, the currents flowing through the transformers TR1 and TR2 are identical to each other. For example, a number of turns of the primary winding LPR1 is the same as a number of turns of the primary winding LPR2. A voltage across the primary winding LPR1 is substantially the same as a voltage across the primary winding LPR2. An inductance value of the primary winding LPR1 is substantially the same as an inductance value of the primary winding LPR2. Numbers of turns of the secondary windings LSR1 to LSR4 are substantially the same as each other. Inductance values of the secondary windings LSR1 to LSR4 are substantially the same as each other. Voltages across the secondary windings LSR1 to LSR4 are substantially the same as each other.

The currents flowing through the transformers TS1 and TS2 are identical to each other. For example, a number of turns of the primary winding LPS1 is the same as a number of turns of the primary winding LPS2. A voltage across the primary winding LPS1 is substantially the same as a voltage across the primary winding LPS2. An inductance value of the primary winding LPS1 is substantially the same as an inductance value of the primary winding LPS2. Numbers of turns of the secondary windings LSS1 to LSS4 are the same as each other. Inductance values of the secondary windings LSS1 to LSS4 are substantially the same as each other. Voltages across the secondary windings LSS1 to LSS4 are substantially the same as each other.

The currents flowing through the transformers TT1 and TT2 are identical to each other. For example, a number of turns of the primary winding LPT1 is the same as a number of turns of the primary winding LPT2. A voltage across the primary winding LPT1 is substantially the same as a voltage across the primary winding LPT2. An inductance value of primary winding LPT1 is substantially the same as an inductance value of the primary winding LPT2. Numbers of turns of the secondary windings LST1 to LST4 are the same as each other. Inductance values of the secondary windings LST1 to LST4 are substantially the same as each other. Voltages across the secondary windings LST1 to LST4 are substantially the same as each other.

In this embodiment, the secondary side circuit 220 includes a synchronous rectifier circuit 221 and a power output circuit 222. The synchronous rectifier circuit 221 is connected to the secondary windings LSR1, LSR2, LSR3, and LSR4 of the first phase transformer circuit TR, the secondary windings LSS1, LSS2, LSS3, and LSS4 of the second phase transformer circuit TS, and the secondary windings LST1, LST2, LST3, and LST4 of the third phase transformer circuit TT. The power output circuit 222 is connected to the synchronous rectifier circuit 221. The power output circuit 222 is configured to output the output power PO.

The synchronous rectifier circuit 221 includes synchronous rectifier switches SR1 to SR12. A first terminal of the synchronous rectifier switch SR1 is connected to a first terminal of the secondary winding LSR1. A second terminal of the synchronous rectifier switch SR1 is connected to a negative power output terminal of the power conversion circuit 200. A second terminal of the secondary winding LSR1 is connected to a positive power output terminal of the power conversion circuit 200. A first terminal of the secondary winding LSR2 is connected to the positive power output terminal. A first terminal of the synchronous rectifier switch SR2 is connected to a second terminal of the secondary winding LSR2. A second terminal of the synchronous rectifier switch SR2 is connected to the negative power output terminal.

A first terminal of the synchronous rectifier switch SR3 is connected to a first terminal of the secondary winding LSR3. A second terminal of the synchronous rectifier switch SR3 is connected to the negative power output terminal. A second terminal of the secondary winding LSR3 is connected to the positive power output terminal. A first terminal of the secondary winding LSR4 is connected to the positive power output terminal. A first terminal of the synchronous rectifier switch SR4 is connected to a second terminal of the secondary winding LSR4. A second terminal of the synchronous rectifier switch SR4 is connected to the negative power output terminal.

A first terminal of the synchronous rectifier switch SR5 is connected to a first terminal of the secondary winding LSS1. A second terminal of the synchronous rectifier switch SR5 is connected to the negative power output terminal. A second terminal of the secondary winding LSS1 is connected to the positive power output terminal. A first terminal of the secondary winding LSS2 is connected to the positive power output terminal. A first terminal of the synchronous rectifier switch SR6 is connected to a second terminal of the secondary winding LSS2. A second terminal of the synchronous rectifier switch SR6 is connected to the negative power output terminal.

A first terminal of the synchronous rectifier switch SR7 is connected to a first terminal of the secondary winding LSS3. A second terminal of the synchronous rectifier switch SR7 is connected to the negative power output terminal. A second terminal of the secondary winding LSS3 is connected to the positive power output terminal. A first terminal of the secondary winding LSS4 is connected to the positive power output terminal. A first terminal of the synchronous rectifier switch SR8 is connected to a second terminal of the secondary winding LSS4. A second terminal of the synchronous rectifier switch SR8 is connected to the negative power output terminal.

A first terminal of the synchronous rectifier switch SR9 is connected to a first terminal of the secondary winding LST1. A second terminal of the synchronous rectifier switch SR9 is connected to the negative power output terminal. A second terminal of the secondary winding LST1 is connected to the positive power output terminal. A first terminal of the secondary winding LST2 is connected to the positive power output terminal. A first terminal of the synchronous rectifier switch SR10 is connected to a second terminal of the secondary winding LST2. A second terminal of the synchronous rectifier switch SR10 is connected to the negative power output terminal.

A first terminal of the synchronous rectifier switch SR11 is connected to a first terminal of the secondary winding LST3. A second terminal of the synchronous rectifier switch SR11 is connected to the negative power output terminal. A second terminal of the secondary winding LST3 is connected to the positive power output terminal. A first terminal of the secondary winding LST4 is connected to the positive power output terminal. A first terminal of the synchronous rectifier switch SR12 is connected to a second terminal of the secondary winding LST4. A second terminal of the synchronous rectifier switch SR12 is connected to the negative power output terminal.

The power output circuit 222 includes an output resistor RO and an output capacitor CO. The output resistor RO is connected between the positive power output terminal and the negative power output terminal. The output capacitor CO is connected between the positive power output terminal and the negative power output terminal.

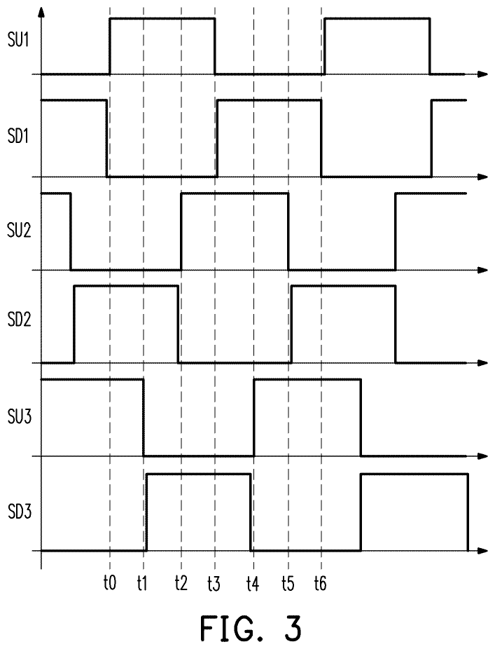

Referring to FIG. 2 and FIG. 3, FIG. 3 is a timing diagram of switching signals according to an embodiment of the disclosure. In this embodiment, the first phase upper arm power switch SWU1 operates in response to a switching signal SU1. The first phase lower arm power switch SWD1 operates in response to a switching signal SD1. The second phase upper arm power switch SWU2 operates in response to a switching signal SU2. The second phase lower arm power switch SWD2 operates in response to a switching signal SD2. The third phase upper arm power switch SWU3 operates in response to a switching signal SU3. The third phase lower arm power switch SWD3 operates in response to a switching signal SD3.

During a period between a time point t0 and a time point t1, a voltage value of the switching signal SU1 is raised to a high voltage level. Therefore, the first phase upper arm power switch SWU1 begins to be turned on. The second phase lower arm power switch SWD2 is turned on in response to a high voltage level of the switching signal SD2. The third phase upper arm power switch SWU3 is turned on in response to a high voltage level of the switch signal SU3. During the process when the first phase upper arm power switch SWU1 is turned on, compared to a period before the time point t0, a current value of the current flowing through the resonant inductor LR1 in a direction D1 gradually decreases. A current value of the current flowing through the primary windings LPR1 and LPR2 in a direction D4 gradually decreases. A current value of the current flowing through the resonant inductor LR3 in the direction D1 gradually increases. A current value of the current flowing through the primary windings LPT1 and LPT2 in a direction D3 also gradually increases. After the current flowing through the first phase upper arm power switch SWU1, the first phase resonant tank 111, the primary windings LPR1 and LPR2 converges with the current flowing through the third phase upper arm power switch SWU3, the third phase resonant tank 113, the primary windings LPT1 and LPT2, a current value of the current flowing through the second phase resonant tank 112 into the second phase node NS in a direction D2 gradually increases. A current value of the current flowing through the primary windings LPS1 and LPS2 in the direction D4 gradually increases.

After the first phase upper arm power switch SWU1 is turned on, the transformers TR1 and TR2 transfer energy located in the primary windings LPR1 and LPR2 to the secondary windings LSR1 to LSR4. At this time, a current value of the current flowing through the resonant inductor LR1 in the direction D1 may increase linearly until the first phase upper arm power switch SWU1 is turned off.

During a period between a time point t1 and a time point t2, the third phase upper arm power switch SWU3 is turned off in response to a low voltage level of the switch signal SU3. A bypass diode of the third phase lower arm power switch SWD3 is turned on due to a resonant current. A voltage difference across the third phase lower arm power switch SWD3 is zero. At this time, the transition from turn-off to turn-on of the third phase lower arm power switch SWD3 is in a zero voltage switching (ZVS) mode. During a period when the first phase upper arm power switch SWU1 and the second phase lower arm power switch SWD2 are turned on, when the third phase lower arm power switch SWD3 is turned on, the current flowing through the first phase upper arm power switch SWU1 and the first phase resonant tank 111 equals to the current flowing through the second phase lower arm power switch SWD2 and the second phase resonant tank 112 plus the current flowing through the third phase lower arm power switch SWD3 and the third phase resonant tank 113.

A current value of the current flowing through the resonant inductor LR1 increases. A current value of the current flowing through the primary windings LPR1 and LPR2 decreases to zero, and then starts to increase in the direction D3. A current value of the current flowing through the resonant inductor LR2 decreases. A current value of the current flowing through the primary windings LPS1 and LPS2 in the direction D4 increases. A current value of the current flowing through the resonant inductor LR3 decreases. A current value of the current flowing through the primary windings LPT1 and LPT2 in the direction D3 increases.

During a period between the time point t2 and a time point t3, the second phase lower arm power switch SWD2 is turned off. A bypass diode of the second phase upper arm power switch SWU2 is turned on due to the resonant current. A voltage difference across the second phase upper arm power switch SWU2 is zero. At this time, the transition from turn-off to turn-on of the second phase upper arm power switch SWU2 is in the ZVS mode. During a period when the first phase upper arm power switch SWU1 and the third phase lower arm power switch SWD3 are turned on, when the second phase upper arm power switch SWU2 is turned on, the current flowing through the third phase lower arm power switch SWD3 and the third phase resonant tank 113 equals to the current flowing through the first phase upper arm power switch SWU1 and the first phase resonant tank 111 plus the current flowing through the second phase upper arm power switch SWU2 and the second phase resonant tank 112.

A current value of the current flowing through the resonant inductor LR1 in the direction D1 increases. A current value of the current flowing through the primary windings LPR1 and LPR2 in the direction D3 increases. A current value of the current flowing through the resonant inductor LR2 in the direction D2 decreases. A current value of the current flowing through the primary windings LPS1 and LPS2 in the direction D4 decreases. A current value of the current flowing through the resonant inductor LR3 in the direction D2 increases. A current value of the current flowing through the primary windings LPT1 and LPT2 in the direction D3 increases.

During a period between the time point t3 and a time point t4, the first phase upper arm power switch SWU1 is turned off. A bypass diode of the first phase upper arm power switch SWU1 is turned on due to the resonant current. A voltage difference across the first phase lower arm power switch SWD1 is zero. At this time, the transition from turn-off to turn-on of the first phase lower arm power switch SWD1 is in the ZVS mode. During a period when the second phase upper arm power switch SWU2 and the third phase lower arm power switch SWD3 are turned on, when the first phase lower arm power switch SWD1 is turned on, the current flowing through the second phase upper arm power switch SWU2 and the second phase resonant tank 112 equals to the current flowing through the first phase lower arm power switch SWD1 and the first phase resonant tank 111 plus the current flowing through the third phase lower arm power switch SWD3 and the third phase resonant tank 113.

A current value of the current flowing through the resonant inductor LR1 in the direction D1 decreases. A current value of the current flowing through the primary windings LPR1 and LPR2 in the direction D3 increases to the current value of the current flowing through resonant inductor LR1, and then starts to decrease. A current value of the current flowing through the resonant inductor LR2 in the direction D1 increases. A current value of the current flowing through the primary windings LPS1 and LPS2 in the direction D4 decreases to zero, and then starts to increase in the direction D3. A current value of the current flowing through the resonant inductor LR3 in the direction D2 decreases. A current value of the current flowing through the primary windings LPT1 and LPT2 in the direction D4 increases.

During a period between the time point t4 and a time point t5, the third phase lower arm power switch SWD3 is turned off. A bypass diode of the third phase upper arm power switch SWU3 is turned on due to the resonant current. A voltage difference across the third phase upper arm power switch SWU3 is zero. At this time, the transition from turn-off to turn-on of the third phase upper arm power switch SWU3 is in the ZVS mode. During a period when the first phase lower arm power switch SWD1 and the second phase upper arm power switch SWU2 are turned on, when the third phase upper arm power switch SWU3 is turned on, the current flowing through the first phase lower arm power switch SWD1 and the first phase resonant tank 111 equals to the current flowing through the second phase upper arm power switch SWU2 and the second phase resonant tank 112 plus the current flowing through the third phase upper arm power switch SWU3 and the third phase resonant tank 113.

A current value of the current flowing through the resonant inductor LR1 in the direction D2 increases. A current value of the current flowing through the primary windings LPR1 and LPR2 in the direction D3 decreases to zero, and then starts to increase in the direction D4. A current value of the current flowing through the resonant inductor LR2 in the direction D1 increases. A current value of the current flowing through the primary windings LPS1 and LPS2 in the direction D3 increases. A current value of the current flowing through the resonant inductor LR3 in the direction D2 decreases. A current value of the current flowing through the primary windings LPT1 and LPT2 in the direction D4 decreases.

During a period between the time point t5 and a time point t6, the second phase upper arm power switch SWU2 is turned off. A bypass diode of the second phase lower arm power switch SWD2 is turned on due to the resonant current. A voltage difference across the second phase lower arm power switch SWD2 is zero. At this time, the transition from turn-off to turn-on of the second phase lower arm power switch SWD2 is in the ZVS mode. During a period when the first phase lower arm power switch SWD1 and the third phase upper arm power switch SWU3 are turned on, when the second phase lower arm power switch SWD2 is turned on, the current flowing through the third phase upper arm power switch SWU3 and the third phase resonant tank 113 equals to the current flowing through the first phase lower arm power switch SWD1 and the first phase resonant tank 111 plus the current flowing through the second phase lower arm power switch SWD2 and the second phase resonant tank 112.

A current value of the current flowing through the resonant inductor LR1 in the direction D2 decreases. A current value of the current flowing through the primary windings LPR1 and LPR2 in the direction D4 decreases. A current value of the current flowing through the resonant inductor LR2 in the direction D1 decreases. A current value of the current flowing through the primary windings LPS1 and LPS2 in the direction D3 increases to the current value of the current flowing through the resonant inductor LR2, and then starts to decrease. A current value of the current flowing through the resonant inductor LR3 in the direction D1 increases. A current value of the current flowing through the primary windings LPT1 and LPT2 in the direction D4 decreases to zero, and then starts to increase in the direction D3.

After the time point t6, the operation from the time point t0 to the time point t6 restarts.

It is worth mentioning here that primary side currents provided to the primary windings LPR1, LPR2, LPS1, LPS2, LPT1, and LPT2 are all sinusoidal. Secondary side currents of the transformers TR1, TR2, TS1, TS2, TT1, and TT2 are absolute current values. Therefore, when the primary side currents of the transformers TR1, TR2, TS1, TS2, TT1, and TT2 flow through a zero-point, the corresponding synchronous rectifier switches are turned off automatically, thereby achieving zero current switching (ZCS) of synchronous rectifier operation.

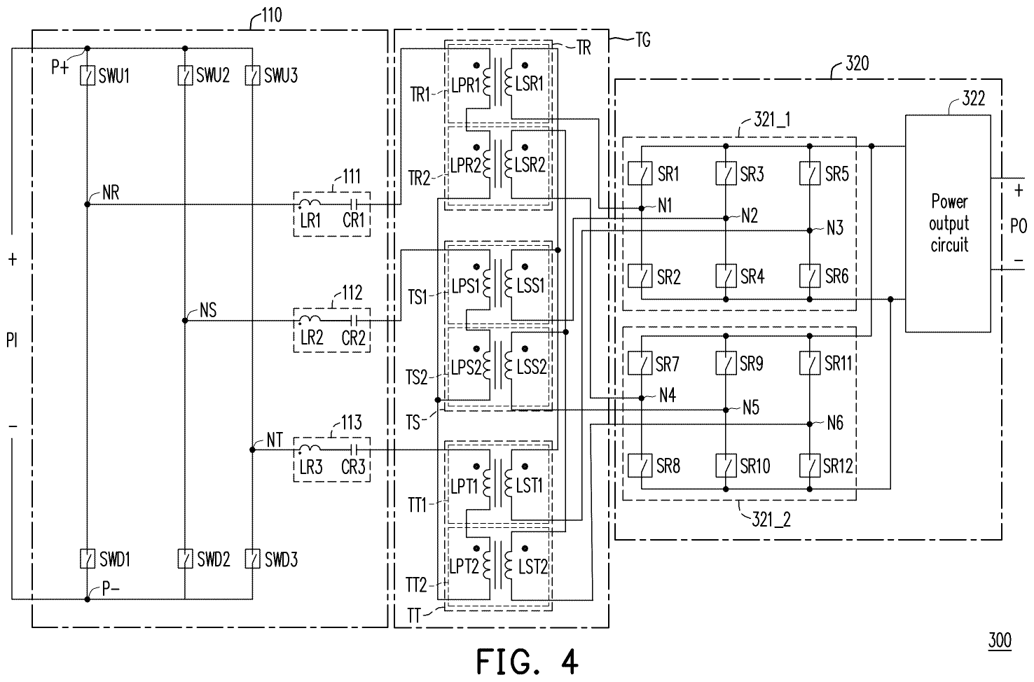

FIG. 4 is a schematic diagram of a power conversion circuit according to an embodiment of the disclosure. In this embodiment, a power conversion circuit 300 includes a series transformer circuit TG, a primary side circuit 110, and a secondary side circuit 320. The series transformer circuit TG includes a first phase transformer circuit TR, a second phase transformer circuit TS, and a third phase transformer circuit TT. The first phase transformer circuit TR includes transformers TR1 and TR2. The second phase transformer circuit TS includes transformers TS1 and TS2. The third phase transformer circuit TT includes transformers TT1 and TT2. The transformer TR1 includes a primary winding LPR1 and a secondary winding LSR1. The transformer TR2 includes a primary winding LPR2 and a secondary winding LSR2. The transformer TS1 includes a primary winding LPS1 and a secondary winding LSS1. The transformer TS2 includes a primary winding LPS2 and a secondary winding LSS2. The transformer TT1 includes a primary winding LPT1 and a secondary winding LST1. The transformer TT2 includes a primary winding LPT2 and a secondary winding LST2.

The connection manners of the primary side circuit 110, the first phase transformer circuit TR, the second phase transformer circuit TS, and the third phase transformer circuit TT has been clearly described in the embodiment of FIG. 1. The primary windings LPR1, LPR2, LPS1, LPS2, LPT1, and LPT2 are connected in the “Y” type connection manner. In this embodiment, the designs of the transformers TR1, TR2, TS1, TS2, TT1, and TT2 are substantially similar.

In this embodiment, the secondary side circuit 320 includes synchronous rectifier circuits 321_1 and 321_2 and a power output circuit 322. The synchronous rectifier circuit 321_1 is connected to the secondary winding LSR1 of the first phase transformer circuit TR, the secondary winding LSS1 of the second phase transformer circuit TS, and the secondary winding LST1 of the third phase transformer circuit TT. The synchronous rectifier circuit 321_2 is connected to the secondary winding LSR2 of the first phase transformer circuit TR, the secondary winding LSS2 of the second phase transformer circuit TS, and the secondary winding LST2 of the third phase transformer circuit TT. The power output circuit 322 is connected to the synchronous rectifier circuits 321_1 and 321_2. The power output circuit 322 is configured to output the output power PO.

In this embodiment, the synchronous rectifier circuit 321_1 includes rectifier nodes N1 to N3. The secondary windings LSR1 and LSS1 are connected in series between the rectifier node N1 and the rectifier node N2. The secondary windings LSR1 and LST1 are connected in series between the rectifier node N1 and the rectifier node N3. The secondary windings LSS1 and LST1 are connected in series between the rectifier node N2 and the rectifier node N3. Therefore, the secondary windings LSR1, LSS1, and LST1 are connected in the “Y”type connection manner.

The synchronous rectifier circuit 321_1 also includes synchronous rectifier switches SR1 to SR6. A first terminal of the synchronous rectifier switch SR1 is connected to a positive power output terminal of the power conversion circuit 300. A second terminal of the synchronous rectifier switch SR1 is connected to the rectifier node N1. A first terminal of the synchronous rectifier switch SR2 is connected to the rectifier node N1. A second terminal of the synchronous rectifier switch SR2 is connected to a negative power output terminal of the power conversion circuit 300. A first terminal of the synchronous rectifier switch SR3 is connected to the positive power output terminal. A second terminal of the synchronous rectifier switch SR3 is connected to the rectifier node N2. A first terminal of the synchronous rectifier switch SR4 is connected to the rectifier node N2. A second terminal of the synchronous rectifier switch SR4 is connected to the negative power output terminal. A first terminal of the synchronous rectifier switch SR5 is connected to the positive power output terminal. A second terminal of the synchronous rectifier switch SR5 is connected to the rectifier node N3. A first terminal of the synchronous rectifier switch SR6 is connected to the rectifier node N3. A second terminal of the synchronous rectifier switch SR6 is connected to the negative power output terminal.

In this embodiment, the synchronous rectifier circuit 321_2 includes rectifier nodes N4 to N6. The secondary windings LSR2 and LSS2 are connected in series between the rectifier node N4 and the rectifier node N5. The secondary windings LSR2 and LST2 are connected in series between the rectifier node N4 and the rectifier node N6. The secondary windings LSS2 and LST2 are connected in series between the rectifier node N5 and the rectifier node N6. Therefore, the secondary windings LSR2, LSS2, and LST2 are connected in the “Y” type connection manner. Furthermore, the power conversion circuit 300 is a “Y-Y”type of a 3-phase LLC converter.

The synchronous rectifier circuit 321_2 further includes synchronous rectifier switches SR7 to SR12. A first terminal of the synchronous rectifier switch SR7 is connected to the positive power output terminal. A second terminal of the synchronous rectifier switch SR7 is connected to the rectifier node N4. A first terminal of the synchronous rectifier switch SR8 is connected to rectifier node N4. A second terminal of the synchronous rectifier switch SR8 is connected to the negative power output terminal. A first terminal of the synchronous rectifier switch SR9 is connected to the positive power output terminal. A second terminal of synchronous rectifier switch SR9 is connected to rectifier node N5. A first terminal of the synchronous rectifier switch SR10 is connected to the rectifier node N5. A second terminal of the synchronous rectifier switch SR10 is connected to the negative power output terminal. A first terminal of the synchronous rectifier switch SR11 is connected to the positive power output terminal. A second terminal of the synchronous rectifier switch SR11 is connected to the rectifier node N6. A first terminal of the synchronous rectifier switch SR12 is connected to the rectifier node N6. A second terminal of the synchronous rectifier switch SR12 is connected to the negative power output terminal.

In this embodiment, a timing of a ripple of a current output by the synchronous rectifier circuit 321_1 is different from a timing of a ripple of a current output by the synchronous rectifier circuit 321_2. Therefore, when the power output circuit 322 superimposes the currents output by the synchronous rectifier circuits 321_1 and 321_2, the ripple fluctuation of the current of the output power PO may be reduced. In this embodiment, the power output circuit 322 may sum the power supplies output by the synchronous rectifier circuits 321_1 and 321_2, and generate output power PO according to the summed power supplies.

In some embodiments, the power output circuit 322 may select the power output by one of the synchronous rectifier circuits 321_1 and 321_2, and generate output power PO according to the selected power.

In this embodiment, the timing diagram of the switch signals SU1 to SU3 and SD1 to SD3 of FIG. 3 may be applicable to the power conversion circuit 300.

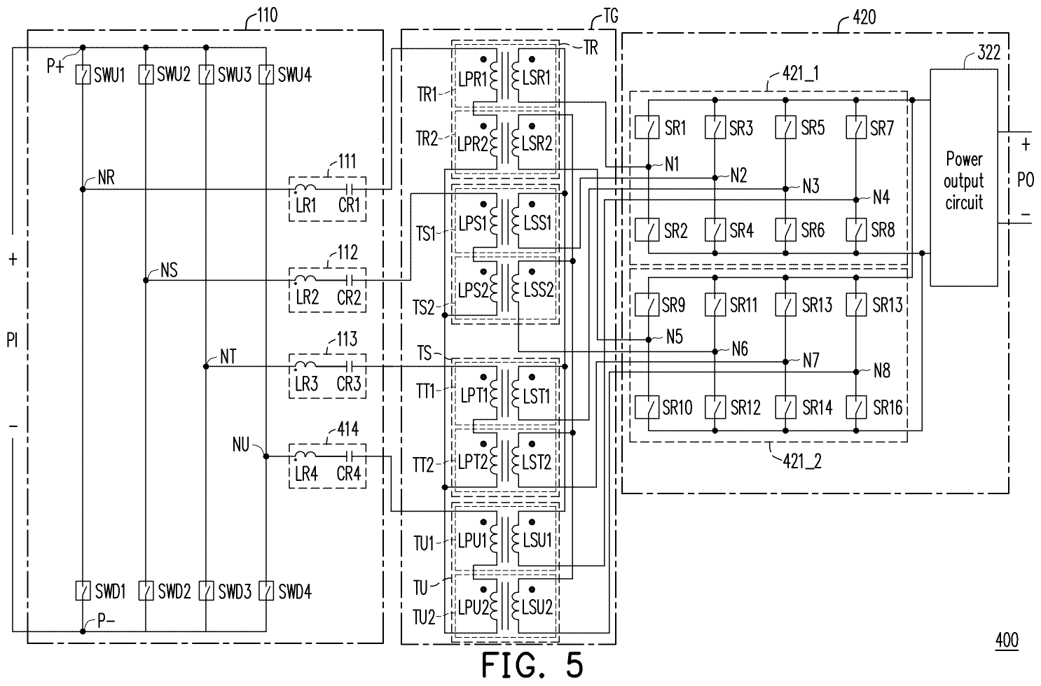

FIG. 5 is a schematic diagram of a power conversion circuit according to an embodiment of the disclosure. In this embodiment, a power conversion circuit 400 includes a series transformer circuit TG, a primary side circuit 410, and a secondary side circuit 420. The series transformer circuit TG of the power conversion circuit 400 includes a first phase transformer circuit TR, a second phase transformer circuit TS, a third phase transformer circuit TT, and a fourth phase transformer circuit TU. The first phase transformer circuit TR includes transformers TR1 and TR2. The second phase transformer circuit TS includes transformers TS1 and TS2. The third phase transformer circuit TT includes transformers TT1 and TT2. The fourth phase transformer circuit TU includes transformers TU1 and TU2. The transformer TR1 includes a primary winding LPR1 and a secondary winding LSR1. The transformer TR2 includes a primary winding LPR2 and a secondary winding LSR2. The transformer TS1 includes a primary winding LPS1 and a secondary winding LSS1. The transformer TS2 includes a primary winding LPS2 and a secondary winding LSS2. The transformer TT1 includes a primary winding LPT1 and secondary winding LST1. The transformer TT2 includes a primary winding LPT2 and a secondary winding LST2. The transformer TU1 includes a primary winding LPU1 and a secondary winding LSU1. The transformer TU2 includes a primary winding LPU2 and a secondary winding LSU2.

The primary side circuit 410 includes a first phase node NR, a second phase node NS, a third phase node NT, a fourth phase node NU, a first phase resonant tank 111, a second phase resonant tank 112, a third phase resonant tank 113, a fourth phase resonant tank 414, a first phase upper arm power switch SWU1, a second phase upper arm power switch SWU2, a third phase upper arm power switch SWU3, a fourth phase upper arm power switch SWU4, a first phase lower arm power switch SWD1, a second phase lower arm power switch SWD2, a third phase lower arm power switch SWD3, and a fourth phase lower arm power switch SWD4. The connection manners of the first phase node NR, the second phase node NS, the third phase node NT, the first phase resonant tank 111, the second phase resonant tank 112, the third phase resonant tank 113, the first phase upper arm power switch SWU1, the second phase upper arm power switch SWU2, the third phase upper arm power switch SWU3, the first phase lower arm power switch SWD1, the second phase lower arm power switch SWD2, the third phase lower arm power switch SWD3, and the series transformer circuit TG has been clearly described in the embodiment of FIG. 2, and are not repeated here.

In this embodiment, the fourth phase resonant tank 414 includes a resonant inductor LR4 and a resonant capacitor CR4.

In this embodiment, a first terminal of the fourth phase upper arm power switch SWU4 is connected to the positive power terminal P+of the input voltage source PI. A second terminal of the fourth phase upper arm power switch SWU4 is connected to the fourth phase node NU. The first terminal of the fourth phase lower arm power switch SWD4 is connected to the fourth phase node NU. The second terminal of the fourth phase lower arm power switch SWD4 is connected to the negative power terminal P-of the input voltage source PI. The first phase resonant tank 111, the fourth phase resonant tank 414, and the primary windings LPR1, LPR2, LPU1, and LPU2 are connected in series between the first phase node NR and the fourth phase node NU. The second phase resonant tank 112, the fourth phase resonant tank 414, and the primary windings LPS1, LPS2, LPU1, and LPU2 are connected in series between the second phase node NS and the fourth phase node NU. The third phase resonant tank 113, the fourth phase resonant tank 414, and the primary windings LPT1, LPT2, LPU1, and LPU2 are connected in series between the third phase node NT and the fourth phase node NU.

In this embodiment, the secondary side circuit 420 includes synchronous rectifier circuits 421_1 and 421_2 and a power output circuit 322. The synchronous rectifier circuit 421_1 is connected to secondary windings LSR1, LSS1, LST1, and LSU1. The synchronous rectifier circuit 421_2 is connected to secondary windings LSR2, LSS2, LST2, and LSU2. In this embodiment, the synchronous rectifier circuit 421_1 includes rectifier nodes N1 to N4 and synchronous rectifier switches SR1 to SR8. The secondary windings LSR1 and LSS1 are connected in series between the rectifier node N1 and the rectifier node N2. The secondary windings LSR1 and LST1 are connected in series between the rectifier node N1 and the rectifier node N3. The secondary windings LSS1 and LST1 are connected in series between the rectifier node N2 and the rectifier node N3. The secondary windings LSR1 and LSU1 are connected in series between the rectifier node N1 and the rectifier node N4. The secondary windings LSS1 and LSU1 are connected in series between the rectifier node N2 and the rectifier node N4. The secondary windings LST1 and LSU1 are connected in series between the rectifier node N3 and the rectifier node N4.

A first terminal of the synchronous rectifier switch SR1 is connected to a positive power terminal of the power conversion circuit 400. A second terminal of the synchronous rectifier switch SR1 is connected to rectifier node N1. A first terminal of the synchronous rectifier switch SR2 is connected to the rectifier node N1. A second terminal of the synchronous rectifier switch SR2 is connected to a negative power terminal of the power conversion circuit 400. A first terminal of the synchronous rectifier switch SR3 is connected to the positive power terminal. A second terminal of the synchronous rectifier switch SR3 is connected to the rectifier node N2. A first terminal of the synchronous rectifier switch SR4 is connected to the rectifier node N2. A second terminal of the synchronous rectifier switch SR4 is connected to the negative power terminal. A first terminal of the synchronous rectifier switch SR5 is connected to the positive power terminal. A second terminal of the synchronous rectifier switch SR5 is connected to the rectifier node N3. A first terminal of the synchronous rectifier switch SR6 is connected to the rectifier node N3. A second terminal of the synchronous rectifier switch SR6 is connected to the negative power terminal. A first terminal of the synchronous rectifier switch SR7 is connected to the positive power terminal. A second terminal of the synchronous rectifier switch SR7 is connected to the rectifier node N4. A first terminal of the synchronous rectifier switch SR8 is connected to the rectifier node N4. A second terminal of the synchronous rectifier switch SR8 is connected to the negative power terminal.

The synchronous rectifier circuit 421_2 includes rectifier nodes N5 to N8 and synchronous rectifier switches SR9 to SR16. The secondary windings LSR2 and LSS2 are connected in series between the rectifier node N5 and the rectifier node N6. The secondary windings LSR2 and LST2 are connected in series between the rectifier node N5 and the rectifier node N7. The secondary windings LSS2 and LST2 are connected in series between the rectifier node N6 and the rectifier node N7. The secondary windings LSR2 and LSU2 are connected in series between the rectifier node N5 and the rectifier node N8. The secondary windings LSS2 and LSU2 are connected in series between the rectifier node N6 and the rectifier node N8. The secondary windings LST2 and LSU2 are connected in series between the rectifier node N7 and the rectifier node N8.

A first terminal of the synchronous rectifier switch SR9 is connected to the positive power terminal. A second terminal of the synchronous rectifier switch SR9 is connected to the rectifier node N5. A first terminal of the synchronous rectifier switch SR10 is connected to the rectifier node N5. A second terminal of the synchronous rectifier switch SR10 is connected to the negative power terminal. A first terminal of the synchronous rectifier switch SR11 is connected to the positive power terminal. A second terminal of the synchronous rectifier switch SR11 is connected to the rectifier node N6. A first terminal of the synchronous rectifier switch SR12 is connected to the rectifier node N6. A second terminal of the synchronous rectifier switch SR12 is connected to the negative power terminal. A first terminal of the synchronous rectifier switch SR13 is connected to the positive power terminal. A second terminal of the synchronous rectifier switch SR13 is connected to the rectifier node N7. A first terminal of the synchronous rectifier switch SR14 is connected to the rectifier node N7. A second terminal of the synchronous rectifier switch SR14 is connected to the negative power terminal. A first terminal of the synchronous rectifier switch SR15 is connected to the positive power terminal. A second terminal of the synchronous rectifier switch SR15 is connected to the rectifier node N8. A first terminal of the synchronous rectifier switch SR16 is connected to the rectifier node N8. A second terminal of the synchronous rectifier switch SR16 is connected to the negative power terminal.

In this embodiment, a timing of a ripple of a current output by the synchronous rectifier circuit 421_1 is different from a timing of a ripple of a current output by the synchronous rectifier circuit 421_2. Therefore, when the power output circuit 322 superimposes the currents output by the synchronous rectifier circuits 421_1 and 421_2, the ripples of the different timings are also superimposed. The ripple fluctuation of the current of the output power PO may be reduced. In this embodiment, the power output circuit 322 may sum the power output by the synchronous rectifier circuits 421_1 and 421_2, and generate output power PO according to the summed power.

In some embodiments, the power output circuit 322 may select the power output by one of the synchronous rectifier circuits 421_1 and 421_2, and generate output power PO according to the selected power.

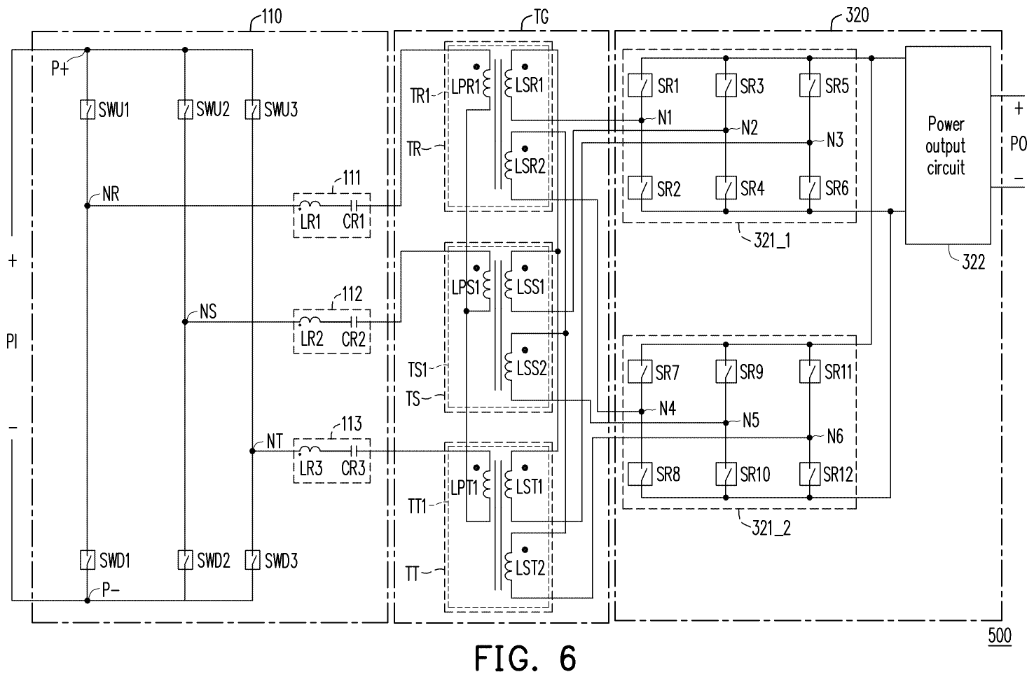

FIG. 6 is a schematic diagram of a power conversion circuit according to an embodiment of the disclosure. In this embodiment, a power conversion circuit 500 includes a series transformer circuit TG, a primary side circuit 110, and a secondary side circuit 320. The series transformer circuit TG includes a first phase transformer circuit TR, a second phase transformer circuit TS, and a third phase transformer circuit TT. The first phase transformer circuit TR includes a transformer TR1. The second phase transformer circuit TS includes a transformer TS1. The third phase transformer circuit TT includes a transformer TT1. The transformer TR1 includes a primary winding LPR1 and a secondary windings LSR1 and LSR2. The transformer TS1 includes a primary winding LPS1 and secondary windings LSS1 and LSS2. The transformer TT1 includes a primary winding LPT1 and secondary windings LST1 and LST2.

The first phase resonant tank 111, the second phase resonant tank 112, and the primary windings LPR1 and LPS1 are connected in series between the first phase node NR and the second phase node NS. The first phase resonant tank 111, the third phase resonant tank 113, and the primary windings LPR1 and LPT1 are connected in series between the first phase node NR and the third phase node NT. The second phase resonant tank 112, the third phase resonant tank 113, and the primary windings LPS1 and LPT1 are connected in series between the second phase node NS and the third phase node NT. Furthermore, the primary windings LPR1 and LPS1 are connected in series between the first phase resonant tank 111 and the second phase resonant tank 112. The primary windings LPR1 and LPT1 are connected in series between the first phase resonant tank 111 and the third phase resonant tank 113. The primary windings LPS1 and LPT1 are connected in series between the second phase resonant tank 112 and the third phase resonant tank 113.

The secondary windings LSR1 and LSS1 are connected in series between the rectifier node N1 and the rectifier node N2. The secondary windings LSR1 and LST1 are connected in series between the rectifier node N1 and the rectifier node N3. The secondary windings LSS1 and LST1 are connected in series between the rectifier node N2 and the rectifier node N3. The secondary windings LSR2 and LSS2 are connected in series between the rectifier node N4 and the rectifier node N5. The secondary windings LSR2 and LST2 are connected in series between the rectifier node N4 and the rectifier node N6. The secondary windings LSS2 and LST2 are connected in series between the rectifier node N5 and the rectifier node N6.

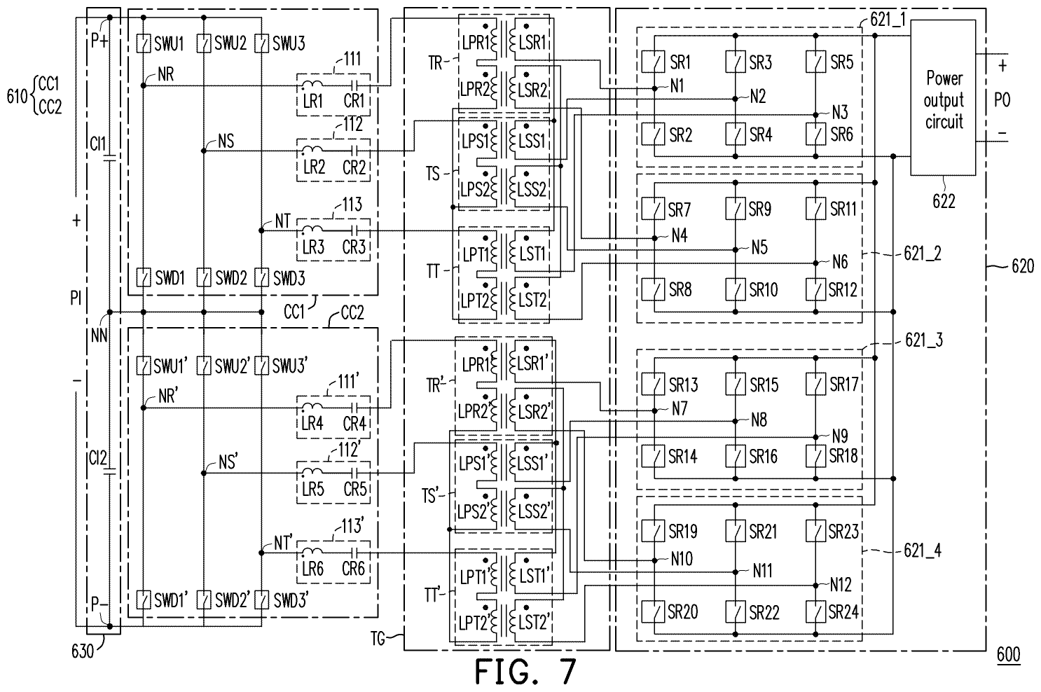

FIG. 7 is a schematic diagram of a power conversion circuit according to an embodiment of the disclosure. In this embodiment, a power conversion circuit 600 includes a series transformer circuit TG, a primary side circuit 610, and a secondary side circuit 620. The series transformer circuit TG includes a first phase transformer circuit TR, a second phase transformer circuit TS, a third phase transformer circuit TT, a fourth phase transformer circuit TR′, a fifth phase transformer circuit TS′, and a sixth phase transformer circuit TT′. The first phase transformer circuit TR includes primary windings LPR1, LPR2 and secondary windings LSR1, LSR2. For example, the primary winding LPR1 and the secondary winding LSR1 are disposed in a transformer of the first phase transformer circuit TR. The primary winding LPR2 and the secondary winding LSR2 are disposed in another transformer of the first phase transformer circuit TR. The second phase transformer circuit TS includes primary windings LPS1, LPS2 and secondary windings LSS1, LSS2. For example, the primary winding LPS1 and secondary winding LSS1 are disposed in a transformer of the second phase transformer circuit TS. The primary winding LPS2 and the secondary winding LSS2 are disposed in another transformer of the second phase transformer circuit TS. The third phase transformer circuit TT includes primary windings LPT1, LPT2 and secondary windings LST1, LST2. For example, the primary winding LPT1 and the secondary winding LST1 are disposed in a transformer of the third phase transformer circuit TT. The primary winding LPT2 and the secondary winding LST2 are disposed in another transformer of the third phase transformer circuit TT.

In this embodiment, the primary side circuit 610 includes circuits CC1 and CC2. The circuits CC1 and CC2 are stacked between the positive power terminal P+ of the input voltage source PI and the negative power terminal P− of the input voltage source PI. The circuit CC1 includes a first phase node NR, a second phase node NS, a third phase node NT, a first phase resonant tank 111, a second phase resonant tank 112, a third phase resonant tank 113, a first phase upper arm power switch SWU1, a second phase upper arm power switch SWU2, a third phase upper arm power switch SWU3, a first phase lower arm power switch SWD1, a second phase lower arm power switch SWD2, and a third phase lower arm power switch SWD3.

A first terminal of the first phase upper arm power switch SWU1 is connected to the positive power terminal P+ of the input voltage source PI. A second terminal of the first phase upper arm power switch SWU1 is connected to the first phase node NR. A first terminal of the first phase lower arm power switch SWD1 is connected to the first phase node NR. A second terminal of the first phase lower arm power switch SWD1 is connected to an intermediate voltage node NN. A first terminal of the second phase upper arm power switch SWU2 is connected to the positive power terminal P+ of the input voltage source PI. A second terminal of the second phase upper arm power switch SWU2 is connected to the second phase node NS. A first terminal of the second phase lower arm power switch SWD2 is connected to the second phase node NS. A second terminal of the second phase lower arm power switch SWD2 is connected to the intermediate voltage node NN. The third phase upper arm power switch SWU3 and the third phase lower arm power switch SWD3 are a third phase half-bridge arm of the primary side circuit 110. A first terminal of the third phase upper arm power switch SWU3 is connected to the positive power terminal P+ of the input voltage source PI. A second terminal of the third phase upper arm power switch SWU3 is connected to the third phase node NT. A first terminal of the third phase lower arm power switch SWD3 is connected to the third phase node NT. A second terminal of the third phase lower arm power switch SWD3 is connected to the intermediate voltage node NN.

The first phase resonant tank 111, the second phase resonant tank 112, and the primary windings LPR1, LPR2, LPS1, and LPS2 are connected in series between the first phase node NR and the second phase node NS. The first phase resonant tank 111, the third phase resonant tank 113, and the primary windings LPR1, LPR2, LPT1, and LPT2 are connected in series between the first phase node NR and the third phase node NT. The second phase resonant tank 112, the third phase resonant tank 113, and the primary windings LPS1, LPS2, LPT1, and LPT2 are connected in series between the second phase node NS and the third phase node NT.

The fourth phase transformer circuit TR′ includes primary windings LPR1′, LPR2′ and secondary windings LSR1′, LSR2′. For example, the primary winding LPR1′ and the secondary winding LSR1′ are disposed in a transformer of the fourth phase transformer circuit TR′. The primary winding LPR2′ and the secondary winding LSR2′ are disposed in another transformer of the fourth phase transformer circuit TR′. The fifth phase transformer circuit TS′ includes primary windings LPS1′, LPS2′ and secondary windings LSS1′, LSS2′. For example, the primary winding LPS1′ and the secondary winding LSS1′ are disposed in a transformer of the fifth phase transformer circuit TS′. The primary winding LPS2′ and the secondary winding LSS2′ are disposed in another transformer of the fifth phase transformer circuit TS′. The sixth phase transformer circuit TT′ includes a primary winding LPT1′ and a secondary winding LST1′. For example, the primary winding LPT1′ and the secondary winding LST1′ are disposed in a transformer of the sixth phase transformer circuit TT′. The primary winding LPT2′ and the secondary winding LST2′ are disposed in another transformer of the sixth phase transformer circuit TT′.

The circuit CC2 includes a fourth phase node NR′, a fifth phase node NS′, a sixth phase node NT′, a fourth phase resonant tank 111′, a fifth phase resonant tank 112′, a sixth phase resonant tank 113′, a fourth phase upper arm power switch SWU1′, a fifth phase upper arm power switch SWU2′, a sixth phase upper arm power switch SWU3′, a fourth phase lower arm power switch SWD1′, a fifth phase lower arm power switch SWD2′, and a sixth phase lower arm power switch SWD3′. The fourth phase resonant tank 111′ includes a resonant inductor LR4 and a resonant capacitor CR4. The fifth phase resonant tank 112′ includes a resonant inductor LR5 and a resonant capacitor CR5. The sixth phase resonant tank 113′ includes a resonant inductor LR6 and a resonant capacitor CR6.

A first terminal of the fourth phase upper arm power switch SWU1′ is connected to the intermediate voltage node NN. A second terminal of the fourth phase upper arm power switch SWU1′ is connected to the fourth phase node NR′. A first terminal of the fourth phase lower arm power switch SWD1′ is connected to the fourth phase node NR′. A second terminal of the fourth phase lower arm power switch SWD1′ is connected to the negative power terminal P− of the input voltage source PI. A first terminal of the fifth phase upper arm power switch SWU2′ is connected to the intermediate voltage node NN. A second terminal of the fifth phase upper arm power switch SWU2′ is connected to the fifth phase node NS′. A first terminal of the fifth phase lower arm power switch SWD2′ is connected to the fifth phase node NS′. A second terminal of the fifth phase lower arm power switch SWD2′ is connected to the negative power terminal P-of the input voltage source PI. A first terminal of the sixth phase upper arm power switch SWU3′ is connected to the intermediate voltage node NN. A second terminal of the sixth phase upper arm power switch SWU3′ is connected to the sixth phase node NT′. A first terminal of the sixth phase lower arm power switch SWD3′ is connected to the sixth phase node NT′. A second terminal of the sixth phase lower arm power switch SWD3′ is connected to the negative power terminal P− of the input voltage source PI.

The fourth phase resonant tank 111′, the fifth phase resonant tank 112′, and the primary windings LPR1′, LPR2′, LPS1′, and LPS2′ are connected in series between the fourth phase node NR′ and the fifth phase node NS′. The fourth phase resonant tank 111′, the sixth phase resonant tank 113′, and the primary windings LPR1′, LPR2′, LPT1′, and LPT2′ are connected in series between the fourth phase node NR′ and the sixth phase node NT′. The fifth phase resonant tank 112′, the sixth phase resonant tank 113′, and the primary windings LPS1′, LPS2′, LPT1′, and LPT2′ are connected in series between the fifth phase node NS′ and the sixth phase node NT′.

In this embodiment, the secondary side circuit 620 includes synchronous rectifier circuits 621_1 to 621_4 and a power output circuit 622. The synchronous rectifier circuit 621_1 includes rectifier nodes N1 to N3 and synchronous rectifier switches SR1 to SR6. A first terminal of the synchronous rectifier switch SR1 is connected to a positive power output terminal of the power conversion circuit 600. A second terminal of the synchronous rectifier switch SR1 is connected to the rectifier node N1. A first terminal of the synchronous rectifier switch SR2 is connected to the rectifier node N1. A second terminal of the synchronous rectifier switch SR2 is connected to a negative power output terminal of the power conversion circuit 600. A first terminal of the synchronous rectifier switch SR3 is connected to the positive power output terminal. A second terminal of the synchronous rectifier switch SR3 is connected to the rectifier node N2. A first terminal of the synchronous rectifier switch SR4 is connected to the rectifier node N2. A second terminal of the synchronous rectifier switch SR4 is connected to the negative power output terminal. A first terminal of the synchronous rectifier switch SR5 is connected to the positive power output terminal. A second terminal of the synchronous rectifier switch SR5 is connected to the rectifier node N3. A first terminal of the synchronous rectifier switch SR6 is connected to the rectifier node N3. A second terminal of the synchronous rectifier switch SR6 is connected to the negative power output terminal. The secondary windings LSR1 and LSS1 are connected in series between the rectifier node N1 and the rectifier node N2. The secondary windings LSR1 and LST1 are connected in series between the rectifier node N1 and the rectifier node N3. The secondary windings LSS1 and LST1 are connected in series between the rectifier node N2 and the rectifier node N3.

The synchronous rectifier circuit 621_2 includes rectifier nodes N4 to N6 and synchronous rectifier switches SR7 to SR12. A first terminal of the synchronous rectifier switch SR7 is connected to the positive power output terminal. A second terminal of the synchronous rectifier switch SR7 is connected to the rectifier node N4. A first terminal of the synchronous rectifier switch SR8 is connected to the rectifier node N4. A second terminal of the synchronous rectifier switch SR8 is connected to the negative power output terminal. A first terminal of the synchronous rectifier switch SR9 is connected to the positive power output terminal. A second terminal of the synchronous rectifier switch SR9 is connected to the rectifier node N5. A first terminal of the synchronous rectifier switch SR10 is connected to the rectifier node N5. A second terminal of the synchronous rectifier switch SR10 is connected to the negative power output terminal. A first terminal of the synchronous rectifier switch SR11 is connected to the positive power output terminal. A second terminal of the synchronous rectifier switch SR11 is connected to the rectifier node N6. A first terminal of the synchronous rectifier switch SR12 is connected to the rectifier node N6. A second terminal of the synchronous rectifier switch SR12 is connected to the negative power output terminal. The secondary windings LSR2 and LSS2 are connected in series between the rectifier node N4 and the rectifier node N5. The secondary windings LSR2 and LST2 are connected in series between the rectifier node N4 and the rectifier node N6. The secondary windings LSS2 and LST2 are connected in series between the rectifier node N5 and the rectifier node N6.

The synchronous rectifier circuit 621_3 includes rectifier nodes N7 to N9 and synchronous rectifier switches SR13 to SR18. A first terminal of the synchronous rectifier switch SR13 is connected to the positive power output terminal. A second terminal of the synchronous rectifier switch SR13 is connected to the rectifier node N7. A first terminal of the synchronous rectifier switch SR14 is connected to the rectifier node N7. A second terminal of the synchronous rectifier switch SR14 is connected to the negative power output terminal. A first terminal of the synchronous rectifier switch SR15 is connected to the positive power output terminal. A second terminal of the synchronous rectifier switch SR15 is connected to the rectifier node N8. A first terminal of the synchronous rectifier switch SR16 is connected to the rectifier node N8. A second terminal of the synchronous rectifier switch SR16 is connected to the negative power output terminal. A first terminal of the synchronous rectifier switch SR17 is connected to the positive power output terminal. A second terminal of the synchronous rectifier switch SR17 is connected to the rectifier node N9. A first terminal of the synchronous rectifier switch SR18 is connected to the rectifier node N9. A second terminal of the synchronous rectifier switch SR18 is connected to the negative power output terminal. The secondary windings LSR1′ and LSS1′ are connected in series between the rectifier node N7 and the rectifier node N8. The secondary windings LSR1′ and LST1′ are connected in series between the rectifier node N7 and the rectifier node N9. The secondary windings LSS1′ and LST1′ are connected in series between the rectifier node N8 and the rectifier node N9.

The synchronous rectifier circuit 621_4 includes rectifier nodes N10 to N12 and synchronous rectifier switches SR19 to SR24. A first terminal of the synchronous rectifier switch SR19 is connected to the positive power output terminal. A second terminal of the synchronous rectifier switch SR19 is connected to the rectifier node N10. A first terminal of the synchronous rectifier switch SR20 is connected to the rectifier node N10. A second terminal of the synchronous rectifier switch SR20 is connected to the negative power output terminal. A first terminal of the synchronous rectifier switch SR21 is connected to the positive power output terminal. A second terminal of the synchronous rectifier switch SR21 is connected to the rectifier node N11. A first terminal of the synchronous rectifier switch SR22 is connected to the rectifier node N11. A second terminal of the synchronous rectifier switch SR22 is connected to the negative power output terminal. A first terminal of the synchronous rectifier switch SR23 is connected to the positive power output terminal. A second terminal of the synchronous rectifier switch SR23 is connected to the rectifier node N12. A first terminal of the synchronous rectifier switch SR24 is connected to the rectifier node N12. A second terminal of the synchronous rectifier switch SR24 is connected to the negative power output terminal. The secondary windings LSR2′ and LSS2′ are connected in series between the rectifier node N10 and the rectifier node N11. The secondary windings LSR2′ and LST2′ are connected in series between the rectifier node N10 and the rectifier node N12. The secondary windings LSS2′ and LST2′ are connected in series between the rectifier node N11 and the rectifier node N12.

In this embodiment, the power output circuit 622 is connected to the synchronous rectifier circuits 621_1 to 621_4. The power output circuit 622 may sum the power output by the synchronous rectifier circuits 621_1 to 621_4, and generate output power PO according to the summed power.

In some embodiments, the power output circuit 622 may select the power output by at least one of the synchronous rectifier circuits 621_1 to 621_4, and generate output power PO according to the selected power.

In this embodiment, a voltage value at the intermediate voltage node NN is controlled to be equal to one-half of a voltage value of the input voltage source PI. The power conversion circuit 600 further includes a voltage balancing circuit 630. The voltage balancing circuit 630 is connected to the intermediate voltage node NN. The voltage balancing circuit 630 controls the voltage value at the intermediate voltage node NN to be one-half of the voltage value of the input voltage source PI.

In this embodiment, the voltage balancing circuit 630 includes capacitors CI1 and CI2. The capacitor CI1 is connected between the positive power terminal P+ of the input voltage source PI and the intermediate voltage node NN. The capacitor CI2 is connected between the intermediate voltage node NN and the negative power terminal P− of the input voltage source PI.

In this embodiment, the circuit CC1, the first phase transformer circuit TR, the second phase transformer circuit TS, the third phase transformer circuit TT, and the synchronous rectifier circuits 621_1 and 621_2 may be a first LLC converter of the power conversion circuit 600. The circuit CC2, the fourth phase transformer circuit TR′, the fifth phase transformer circuit TS′, the sixth phase transformer circuit TT′, and the synchronous rectifier circuits 621_3 and 621_4 may be a second LLC converter of the power conversion circuit 600. The first LLC converter and the second LLC converter are stacked with each other.

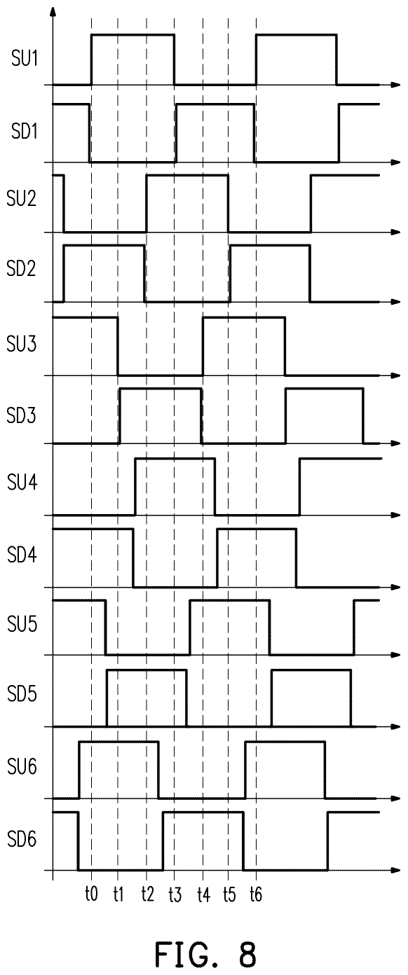

Referring to FIG. 7 and FIG. 8, FIG. 8 is a timing diagram of switching signals according to an embodiment of the disclosure. In this embodiment, the first phase upper arm power switch SWU1 operates in response to the switching signal SU1. The first phase lower arm power switch SWD1 operates in response to the switching signal SD1. The second phase upper arm power switch SWU2 operates in response to the switching signal SU2. The second phase lower arm power switch SWD2 operates in response to the switching signal SD2. The third phase upper arm power switch SWU3 operates in response to the switching signal SU3. The third phase lower arm power switch SWD3 operates in response to the switching signal SD3. The fourth phase upper arm power switch SWU1′ operates in response to a switching signal SU4. The fourth phase lower arm power switch SWD1′ operates in response to a switching signal SD4. The fifth phase upper arm power switch SWU2′ operates in response to a switching signal SU5. The fifth phase lower arm power switch SWD2′ operates in response to a switching signal SD5. The sixth phase upper arm power switch SWU3′ operates in response to a switching signal SU6. The sixth phase lower arm power switch SWD3′ operates in response to a switching signal SD6.

A timing of the switching signals SU1 to SU3 and SD1 to SD3 shown in FIG. 8 is the same as a timing of the switching signals SU1 to SU3 and SD1 to SD3 shown in FIG. 3. A timing of the switching signals SU4 to SU6 and SD4 to SD6 substantially lags a timing of the switching signals SU1 to SU3 and SD1 to SD3 by about 90°. Therefore, a timing of a ripple of a current provided by the second LLC converter substantially lags a timing of a ripple of a current provided by the first LLC converter by about 90°. The power output circuit 622 superimposes the current provided by the first LLC converter and the current provided by the second LLC converter. The aforementioned ripples of different timings are also superimposed. Therefore, the ripple fluctuation of the current of the output power PO may be reduced.

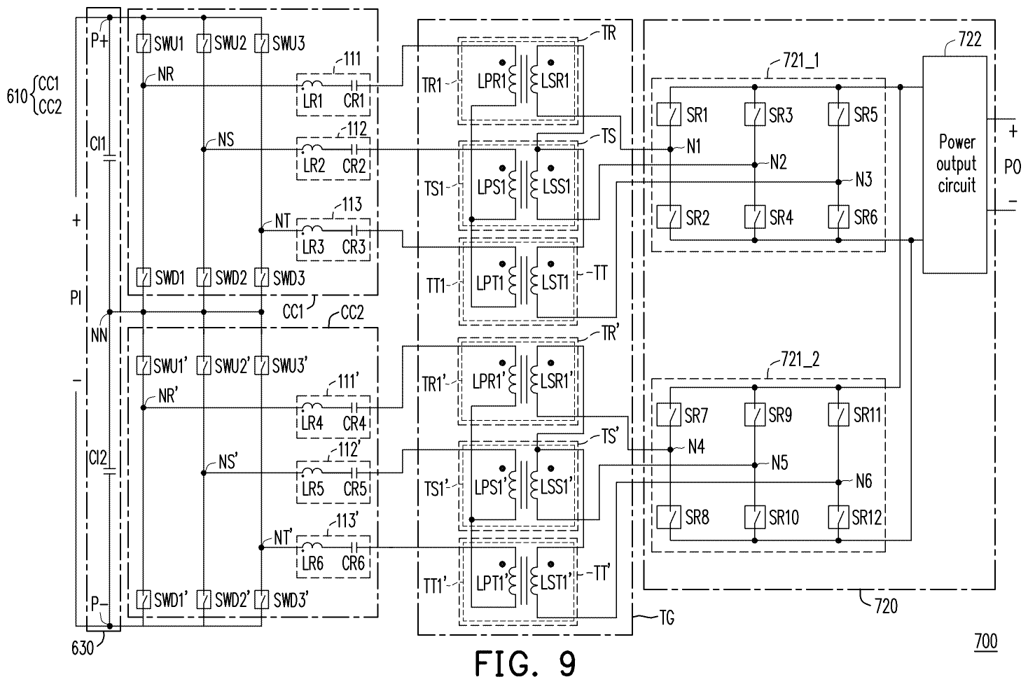

FIG. 9 is a schematic diagram of a power conversion circuit according to an embodiment of the disclosure. In this embodiment, a power conversion circuit 700 includes a series transformer circuit TG, a primary side circuit 610, a secondary side circuit 720, and a voltage balancing circuit 630. The series transformer circuit TG includes a first phase transformer circuit TR, a second phase transformer circuit TS, a third phase transformer circuit TT, a fourth phase transformer circuit TR′, a fifth phase transformer circuit TS′, and a sixth phase transformer circuit TT′. The first phase transformer circuit TR includes a transformer TR1. The transformer TR1 includes a primary winding LPR1 and a secondary winding LSR1. The second phase transformer circuit TS includes a transformer TS1. The transformer TS1 includes a primary winding LPS1 and a secondary winding LSS1. The third phase transformer circuit TT includes a transformer TT1. The transformer TT1 includes a primary winding LPT1 and a secondary winding LST1. The fourth phase transformer circuit TR′ includes a transformer TR1′. The transformer TR1′ includes a primary winding LPR1′ and a secondary winding LSR1′. The fifth phase transformer circuit TS′ includes a transformer TS1′. The transformer TS1′ includes a primary winding LPS1′ and a secondary winding LSS1′. The sixth phase transformer circuit TT′ includes a transformer TT1′. The transformer TT1′ includes a primary winding LPT1′ and a secondary winding LST1′.

The first phase resonant tank 111, the second phase resonant tank 112, and the primary windings LPR1, LPS1 are connected in series between the first phase node NR and the second phase node NS. The first phase resonant tank 111, the third phase resonant tank 113, and the primary windings LPR1 and LPT1 are connected in series between the first phase node NR and the third phase node NT. The second phase resonant tank 112, the third phase resonant tank 113, and the primary windings LPS1 and LPT1 are connected in series between the second phase node NS and the third phase node NT. The fourth phase resonant tank 111′, the fifth phase resonant tank 112′, and the primary windings LPR1′ and LPS1′ are connected in series between the fourth phase node NR′ and the fifth phase node NS′. The fourth phase resonant tank 111′, the sixth phase resonant tank 113′, and the primary windings LPR1′ and LPT1′ are connected in series between the fourth phase node NR′ and the sixth phase node NT′. The fifth phase resonant tank 112′, the sixth phase resonant tank 113′, and the primary windings LPS1′ and LPT1′ are connected in series between the fifth phase node NS′ and the sixth phase node NT′.

In this embodiment, the secondary side circuit 720 includes synchronous rectifier circuits 721_1 and 721_2 and a power output circuit 722. The synchronous rectifier circuit 721_1 includes rectifier nodes N1 to N3 and synchronous rectifier switches SR1 to SR6. The circuit implementation of the synchronous rectifier circuit 721_1 is similar to the circuit implementation of the synchronous rectifier circuit 621_1, and is not repeated here. The secondary windings LSR1 and LSS1 are connected in series between the rectifier node N1 and the rectifier node N2. The secondary windings LSR1 and LST1 are connected in series between the rectifier node N1 and the rectifier node N3. The secondary windings LSS1 and LST1 are connected in series between the rectifier node N2 and the rectifier node N3.

The synchronous rectifier circuit 721_2 includes rectifier nodes N4 to N6 and synchronous rectifier switches SR7 to SR12. The circuit implementation of the synchronous rectifier circuit 721_2 is similar to the circuit implementation of the synchronous rectifier circuit 621_2, and is not repeated here. The secondary windings LSR1′ and LSS1′ are connected in series between the rectifier node N4 and the rectifier node N5. The secondary windings LSR1′ and LST1′ are connected in series between the rectifier node N4 and the rectifier node N6. The secondary windings LSS1′ and LST1′ are connected in series between the rectifier node N5 and the rectifier node N6.

The power output circuit 722 is connected to the synchronous rectifier circuits 721_1 and 721_2. The power output circuit 722 is configured to output the output power PO.

In summary, the series transformer circuit of the power conversion circuit includes a first phase transformer circuit, a second phase transformer circuit, and a third phase transformer circuit. The primary side circuit of the power conversion circuit includes a first phase node, a second phase node, a third phase node, a first phase resonant tank, a second phase resonant tank, and a third phase resonant tank. The first phase resonant tank, the second phase resonant tank, at least one primary winding of the first phase transformer circuit, and at least one primary winding of the second phase transformer circuit are connected in series between the first phase node and the second phase node. The first phase resonant tank, the third phase resonant tank, at least one primary winding of the first phase transformer circuit, and at least one primary winding of the third phase transformer circuit are connected in series between the first phase node and the third phase node. The second phase resonant tank, the third phase resonant tank, at least one primary winding of the second phase transformer circuit, and at least one primary winding of the third phase transformer circuit are connected in series between the second phase node and the third phase node. The first phase transformer circuit, the second phase transformer circuit, and the third phase transformer circuit share the same primary side circuit. In this way, a volume of the power conversion circuit may be reduced.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. A power conversion circuit, comprising:
a series transformer circuit, comprising a first phase transformer circuit, a second phase transformer circuit, and a third phase transformer circuit;
a primary side circuit, comprising a first phase node, a second phase node, a third phase node, a first phase resonant tank, a second phase resonant tank, and a third phase resonant tank, wherein:
the first phase resonant tank, the second phase resonant tank, at least one primary winding of the first phase transformer circuit, and at least one primary winding of the second phase transformer circuit are connected in series between the first phase node and the second phase node,
the first phase resonant tank, the third phase resonant tank, the at least one primary winding of the first phase transformer circuit, and at least one primary winding of the third phase transformer circuit are connected in series between the first phase node and the third phase node, and
the second phase resonant tank, the third phase resonant tank, the at least one primary winding of the second phase transformer circuit, and the at least one primary winding of the third phase transformer circuit are connected in series between the second phase node and the third phase node; and
a secondary side circuit, connected to at least one secondary winding of the first phase transformer circuit, at least one secondary winding of the second phase transformer circuit, and at least one secondary winding of the third phase transformer circuit.

2. The power conversion circuit according to claim 1, wherein the primary side circuit further comprises:
a first phase upper arm power switch, a first terminal of the first phase upper arm power switch connected to a positive power terminal of an input voltage source, and a second terminal of the first phase upper arm power switch connected to the first phase node; and
a first phase lower arm power switch, a first terminal of the first phase lower arm power switch connected to the first phase node, and a second terminal of the first phase lower arm power switch connected to a negative power terminal of the input voltage source.

3. The power conversion circuit according to claim 1, wherein:
the first phase transformer circuit comprises:
a first transformer, comprising a first primary winding,
the second phase transformer circuit comprises:
a second transformer, comprising a second primary winding, and
the first primary winding and the second primary winding are connected in series between the first phase resonant tank and the second phase resonant tank.

4. The power conversion circuit according to claim 3, wherein:
the third phase transformer circuit comprises:
a third transformer, comprising a third primary winding, and
the first primary winding and the third primary winding are connected in series between the first phase resonant tank and the third phase resonant tank.

5. The power conversion circuit according to claim 4, wherein the second primary winding and the third primary winding are connected in series between the second phase resonant tank and the third phase resonant tank.

6. The power conversion circuit according to claim 1, wherein the secondary side circuit comprises:
a synchronous rectifier circuit, connected to at least one secondary winding of the first phase transformer circuit, at least one secondary winding of the second phase transformer circuit, and at least one secondary winding of the third phase transformer circuit; and
a power output circuit, connected to the synchronous rectifier circuit.

7. The power conversion circuit according to claim 1, wherein:
the first phase transformer circuit comprises:
a first transformer, comprising a first primary winding and a first secondary winding; and
a second transformer, comprising a second primary winding and a second secondary winding,
the second phase transformer circuit comprises:
a third transformer, comprising a third primary winding and a third secondary winding; and
a fourth transformer, comprising a fourth primary winding and a fourth secondary winding, and
the first primary winding, the second primary winding, the third primary winding, and the fourth primary winding are connected in series between the first phase resonant tank and the second phase resonant tank.

8. The power conversion circuit according to claim 7, wherein:
the third phase transformer circuit comprises:
a fifth transformer, comprising a fifth primary winding and a fifth secondary winding; and
a sixth transformer, comprising a sixth primary winding and a sixth secondary winding, and
the first primary winding, the second primary winding, the fifth primary winding, and the sixth primary winding are connected in series between the first phase resonant tank and the third phase resonant tank.

9. The power conversion circuit according to claim 8, wherein the third primary winding, the fourth primary winding, the fifth primary winding, and the sixth primary winding are connected in series between the second phase resonant tank and the third phase resonant tank.

10. The power conversion circuit according to claim 8, wherein the secondary side circuit comprises:
a first synchronous rectifier circuit, connected to the first secondary winding, the third secondary winding, and the fifth secondary winding;
a second synchronous rectifier circuit, connected to the second secondary winding, the fourth secondary winding, and the sixth secondary winding; and
a power output circuit, connected to the first synchronous rectifier circuit and the second synchronous rectifier circuit.

11. The power conversion circuit according to claim 10, wherein:
the first synchronous rectifier circuit comprises a first rectifier node, a second rectifier node, and a third rectifier node,
the first secondary winding and the third secondary winding are connected in series between the first rectifier node and the second rectifier node,
the first secondary winding and the fifth secondary winding are connected in series between the first rectifier node and the third rectifier node, and
the third secondary winding and the fifth secondary winding are connected in series between the second rectifier node and the third rectifier node.

12. The power conversion circuit according to claim 11, wherein:
the second synchronous rectifier circuit comprises a fourth rectifier node, a fifth rectifier node, and a sixth rectifier node,
the second secondary winding and the fourth secondary winding are connected in series between the fourth rectifier node and the fifth rectifier node,
the second secondary winding and the sixth secondary winding are connected in series between the fourth rectifier node and the sixth rectifier node, and
the fourth secondary winding and the sixth secondary winding are connected in series between the fifth rectifier node and the sixth rectifier node.

13. The power conversion circuit according to claim 11, wherein the first synchronous rectifier circuit further comprises:
a first synchronous rectifier switch, a first terminal of the first synchronous rectifier switch connected to a positive power output terminal of the power conversion circuit, and a second terminal of the first synchronous rectifier switch connected to the first rectifier node; and
a second synchronous rectifier switch, a first terminal of the second synchronous rectifier switch connected to the first rectifier node, and a second terminal of the second synchronous rectifier switch connected to a negative power output terminal of the power conversion circuit.

14. The power conversion circuit according to claim 10, wherein a timing of a ripple of a current output by the first synchronous rectifier circuit is different from a timing of a ripple of a current output by the second synchronous rectifier circuit.

15. The power conversion circuit according to claim 1, wherein:
the series transformer circuit further comprises a fourth phase transformer circuit,
the primary side circuit further comprises a fourth phase node and a fourth phase resonant tank, and
the first phase resonant tank, the fourth phase resonant tank, the at least one primary winding of the first phase transformer circuit, and at least one primary winding of the fourth phase transformer circuit are connected in series between the first phase node and the fourth phase node.

16. The power conversion circuit according to claim 1, wherein the primary side circuit further comprises:
a first circuit, comprising the first phase node, the second phase node, the third phase node, the first phase resonant tank, the second phase resonant tank, and the third phase resonant tank; and
a second circuit, comprising a fourth phase node, a fifth phase node, a sixth phase node, a fourth phase resonant tank, a fifth phase resonant tank, and a sixth phase resonant tank,
wherein the first circuit and the second circuit are stacked between a positive power terminal of an input voltage source and a negative power terminal of the input voltage source.

17. The power conversion circuit according to claim 16, wherein:
the series transformer circuit further comprises a fourth phase transformer circuit, a fifth phase transformer circuit, and a sixth phase transformer circuit,
the fourth phase resonant tank, the fifth phase resonant tank, at least one primary winding of the fourth phase transformer circuit, and at least one primary winding of the fifth phase transformer circuit are connected in series between the fourth phase node and the fifth phase node,
the fourth phase resonant tank, the sixth phase resonant tank, the at least one primary winding of the fourth phase transformer circuit, and at least one primary winding of the sixth phase transformer circuit are connected in series between the fourth phase node and the sixth phase node, and
the fifth phase resonant tank, the sixth phase resonant tank, the at least one primary winding of the fifth phase transformer circuit, and the at least one primary winding of the sixth phase transformer circuit are connected in series between the fifth phase node and the sixth phase node.

18. The power conversion circuit according to claim 16, wherein:
the first circuit and the second circuit are connected to an intermediate voltage node, and
a voltage value at the intermediate voltage node is equal to one-half of a voltage value of the input voltage source.

19. The power conversion circuit according to claim 18, further comprising:
a voltage balancing circuit, connected to the intermediate voltage node, and configured to control the voltage value at the intermediate voltage node to be one-half of the voltage value of the input voltage source.

20. The power conversion circuit according to claim 19, wherein the voltage balancing circuit comprises:
a first capacitor, connected between the positive power terminal of the input voltage source and the intermediate voltage node; and
a second capacitor, connected between the intermediate voltage node and the negative power terminal of the input voltage source.
